(19) United States
(12) Patent Application Publication
(10) Pub. No.: US 2016/0031371 A1
(43) Pub. Date: Feb. 4, 2016

(54) IN-VEHICLE APPARATUS

(71) Applicant: DENSO CORPORATION, Kariya-city (JP)

(72) Inventor: Tetsuya Kimata, Ichinomiya-shi (JP)

(21) Appl. No.: 14/811,565

(22) Filed: Jul. 28, 2015

(30) Foreign Application Priority Data
Jul. 29, 2014 (JP) 2014-153892

(51) Int. Cl. B60R 1/00; G06T 1/00; B60W 30/06; B60W 30/12; B60W 30/09; B60Q 1/08; H04N 7/18; G06T 7/00

(52) U.S. Cl. CPC B60R 1/00; H04N 7/18; G06T 1/0007; G06T 7/004; B60W 30/12; B60W 30/09; B60Q 1/08; B60W 30/06; G06T 2207/30261; G06T 2207/30256; G06T 2207/30232; B60R 2300/802; B60W 2420/42

(57) ABSTRACT

An in-vehicle apparatus acquires an image around a vehicle. The apparatus includes an image acquisition section having first and second capturing sections acquiring an image, a storage section storing a first picked up image acquired by the first capturing section and a second picked up image acquired by the second capturing section in different storage areas, an abnormality determination section determining presence/absence of an abnormality of the image acquisition section and a communication section based on whether or not there is a match between the first and second picked up images, an image processing section processing, if the absence of an abnormality is determined, at least one of the first and second picked up images or a combined image generated by combining the first and second picked up images to detect identification information around the vehicle, and a vehicle control section outputting a command signal based on the identification information.

### CROSS-REFERENCE TO RELATED APPLICATION

This application is based on and claims the benefit of priority from earlier Japanese Patent Application No. 2014-153892 filed Jul. 29, 2014, the description of which is incorporated herein by reference.

### BACKGROUND

1. Technical Field

The present invention relates to an in-vehicle apparatus which is installed in a vehicle, and in particular relates to an in-vehicle apparatus which acquires an image of the surroundings of the vehicle equipped with the apparatus.

2. Related Art

Image processing apparatuses including imaging devices and microcomputers are well known as apparatuses that are used being installed in vehicles. Specifically, such an image processing apparatus includes an imaging device which picks up an image of the surroundings of the vehicle equipped with the image processor, and a microcomputer which processes the image picked up by the imaging device. The picked up image is processed by the image processing apparatus and, for example, the results of the process are often reflected in the way the vehicle is driven.

If an abnormality has been caused in an image-capturing section of the microcomputer, there is a concern that adverse effects will be caused in the vehicle controls which are based on the results of the image process.

In this regard, a patent document JP-A-2013-211756 discloses a technique related to an imaging device. According to the technique, a predetermined test pattern is generated by an imaging device and data corresponding to the test pattern is stored in a microcomputer. Further, according to the technique, before the imaging device starts imaging, the microcomputer acquires the test pattern from the imaging device and compares the test pattern with the data stored in the microcomputer to detect any abnormality in the image-capturing section.

However, in the technique set forth above, the imaging device is unable to pick up an image while abnormality judgment is being conducted using the test pattern. Further, if there is a route for establishing a connection between a storage section that stores images and the microcomputer, abnormality determination is required to be separately conducted for the route.

### SUMMARY

An embodiment provides an in-vehicle apparatus which is able to conduct abnormality determination in acquiring a picked up image, targeting a route for capturing the picked up image.

As an aspect of the embodiment, an in-vehicle apparatus is provided which acquires an image picked up by an imaging device picking up an image around a vehicle. The apparatus includes: an image acquisition section which includes a first capturing section and a second capturing section acquiring the picked up image; a storage section which is connected to the image acquisition section via a communication section and stores a first picked up image acquired by the first capturing section and a second picked up image acquired by the second capturing section in different storage areas; an abnormality determination section which determines presence/absence of an abnormality of the image acquisition section and the communication section based on whether or not there is a match between the first picked up image and the second picked up image; an image processing section processes, if the abnormality determination section determines the absence of an abnormality, at least one of the first picked up image and the second picked up image stored in the storage section or a combined image generated by combining the first picked up image and the second picked up image, to detect at least one of an obstacle, a preceding vehicle, a preceding pedestrian, a preceding object, a stationary vehicle, a stationary pedestrian, a stationary object, an oncoming vehicle, an oncoming pedestrian, an oncoming object, a lane marker, a road surface condition, a road shape, a light source, a street sign, and a traffic signal as identification information around the vehicle; and a vehicle control section which outputs, based on the identification information detected by the image processing section, a command signal for performing vehicle control related to at least one of collision avoidance, speed warning, lane departure prevention, collision warning, inter-vehicle distance warning, lane departure warning, automatic high beam control, sign display, full speed range adaptive cruise control, lane keeping, lane change accident prevention, blind spot warning, blind spot monitoring, automatic lane change, front cross-traffic alerting, rear cross-traffic alerting, erroneous pedal depression prevention, and automatic parking.

### BRIEF DESCRIPTION OF THE DRAWINGS

In the accompanying drawings:

FIG. 1 is a diagram illustrating a vehicle control system;

FIG. 2 is a flow diagram illustrating a process performed by an image processing apparatus; and

FIG. 3 is a diagram illustrating an abnormality determination process, according to a modification.

### DETAILED DESCRIPTION OF THE PREFERRED EMBODIMENTS

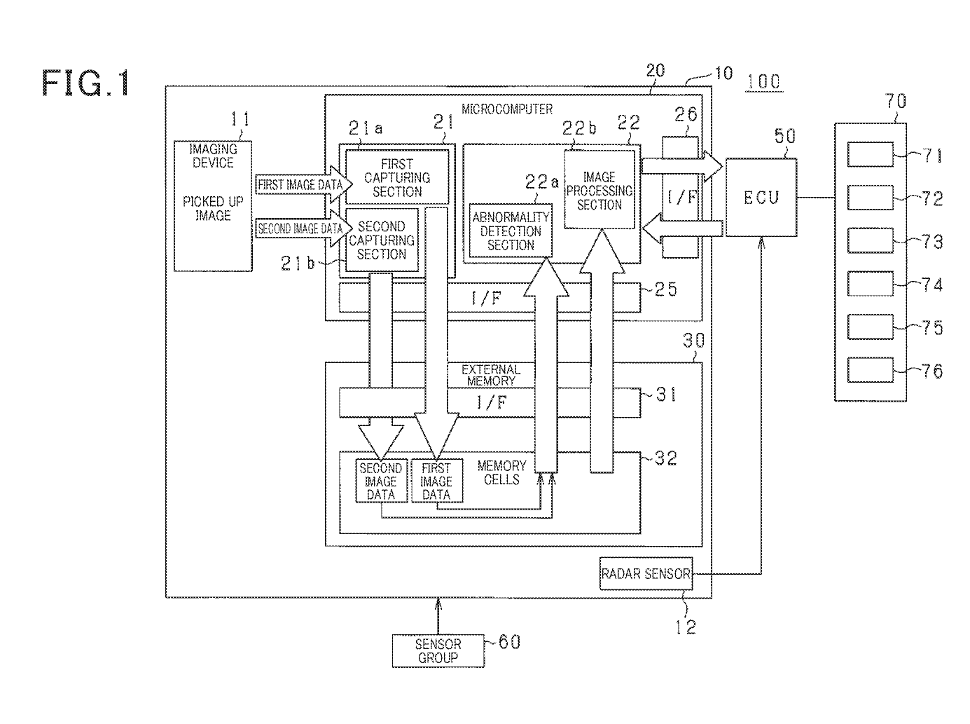

With reference to the accompanying drawings, hereinafter is described an embodiment. FIG. 1 is a diagram illustrating a vehicle control system 100 as an in-vehicle apparatus. The vehicle control system 100 includes an image processing apparatus 10, an ECU 50, a sensor group 60, and a vehicle control actuator 70.

The image processing apparatus 10 includes an imaging device 11, a radar sensor 12, a microcomputer 20, and an external memory 30.

The imaging device 11 is a camera which uses a CMOS (complementary metal-oxide semiconductor) image sensor, or the like and is mounted near a rearview mirror of the vehicle. The camera has a field of view inside the windshield, i.e. in an area of the windshield which is wiped off by the wiper. The camera picks up an image in a predetermined range ahead of the vehicle, repeatedly produces the picked up image, and outputs the produced images to the microcomputer 20. The radar sensor 12 transmits/receives radar waves of millimeter waveband or laser beams to detect an object (target) that has reflected the radar waves and is present within a predetermined search range. The radar sensor 12 generates information including a distance between the object and the vehicle, a relative speed of the object, a lateral position of the object, and the like, for transmission to the ECU 50. It should be noted that, in generating the information associated with the detected object, the imaging device 11 and the radar sensor 12 can also make use of information derived from the sensor group 60.

The microcomputer 20 includes an image-capturing unit 21, interfaces 25 and 26, and a signal processor 22. The external memory 30, which is a DRAM (dynamic random access memory) or the like, includes an interface 31 and memory cells 32.

The image-capturing unit 21 includes a first capturing section 21a and a second capturing section 21b which capture an image picked up and outputted by the imaging device 11 as pieces of image data. Owing to the plurality of capturing sections provided to the image-capturing unit 21, the microcomputer 20 is able to capture a plurality of pieces of image data that are derived from the image picked up and outputted by the imaging device 11. In the description provided below, an image acquired by the first capturing section 21a is referred to as first image data, and an image acquired by the second capturing section 21b is referred to as second image data.

The first and second capturing sections 21a and 21b each have a function of applying a predetermined image process, such as gamma correction, to the acquired image data. The predetermined image process performed by each of the capturing sections enables the microcomputer 20 to extract predetermined objects, as identification information, from the image data.

The objects that can be the identification information include, for example, obstacles, preceding vehicles, preceding pedestrians, preceding objects, stationary vehicles, stationary pedestrians, stationary objects, oncoming vehicles, oncoming pedestrians, oncoming objects, lane markers, road surface conditions, road shapes, light sources, street signs, traffic signals, and the like. However, all of these objects do not have to be necessarily detected, but those objects which are needed for the vehicle control process performed by the ECU 50 only may have to be detected as identification information.

The interface 25 is a communicating means that connects between the microcomputer 20 and the external memory 30 to enable serial communication therebetween. Thus, the interface 25 outputs the first and second image data acquired by the first and second capturing sections 21a and 21b, respectively, to the external memory 30. Further, the interface 25 outputs the first and second image data stored in the memory cells 32 of the external memory 30 to the microcomputer 20.

The interface 31 of the external memory 30 is a communicating means connected to the interface 25 of the microcomputer 20 so as to enable communication. The interface 31 separately acquires the first and second image data. The first and second image data outputted to the external memory 30 via the interface 31 are stored at different addresses of the memory cells 32. For example, the first and second image data are stored at different addresses based on columns, rows and banks which are well known. The first image data is stored at a first address of the memory cells 32, while the second image data is stored at a second address thereof.

The signal processor 22 is mainly configured by a known logic-arithmetic unit including a CPU, a RAM, a ROM, and the like. The CPU includes an abnormality determination processing section 22a that determines an abnormality occurring in a route for acquiring a picked up image (hereinafter referred to as image-capturing route), and an image processing section 22b that processes the picked up image to extract identification information. The ROM stores a program for executing the processes of the abnormality determination processing section 22a and the image processing section 22b. The image-capturing route corresponds to a route through which pieces of image data captured by the microcomputer 20 are inputted to the abnormality determination processing section 22a. The image-capturing route at least includes the first and second capturing sections 21a and 21b, and the interfaces 25 and 31.

The abnormality determination processing section 22a performs an abnormality determination process. In the abnormality determination process, the first and second image data acquired via the image-capturing route are compared to each other. The abnormality determination processing section 22a collectively determines the presence/absence of an abnormality in the image-capturing route on the basis of whether there is a match between the two pieces of image data. In other words, the abnormality determination processing section 22a determines, at a time, the presence/absence of an abnormality in the first and second capturing sections 21a and 21b, and the interfaces 25 and 31.

The image processing section 22b performs a process on the basis of the first and second image data that have been determined as having no abnormality by the abnormality determination processing section 22a and acquired from the external memory 30 via the image-capturing route. Specifically, the image processing section 22b extracts predetermined identification information from at least one of the first and second image data, or from image data generated by combining the first and second image data (combined image data).

The interface 26 of the microcomputer 20 connects between the microcomputer 20 and the ECU 50 so as to enable serial communication therebetween. Specifically, the interface 26 outputs the identification information extracted by the microcomputer 20 to the ECU 50, or outputs a signal (e.g., response signal) from the ECU 50 to the microcomputer 20.

The sensor group 60 includes sensors, such as a vehicle speed sensor, various acceleration sensors, and a steering angle sensor, which detect the behaviors of the vehicle. The sensor group 60 also includes sensors for detecting the surrounding environment of the vehicle, such as a system for outputting position data of the vehicle (e.g., GPS (global positioning system)), a system serving as a supply source of map data (e.g., navigation system), a communication system (e.g., road-to-vehicle communication system, or mobile terminal such as of a smartphone), and a radar. These sensors are used singly, or used in combination to make use of the detection results in combination.

The ECU 50 is mainly configured by a known microcomputer that includes at least a CPU, a RAM and a ROM. The ROM stores a program for realizing various vehicle controls described later using the vehicle control actuator 70, on the basis of the identification information outputted from the image processing section 22b. The ECU 50 uses, as a basis, the identification information inputted via the interface 26 to output command signals for performing the vehicle controls described later. The command signals are outputted to the vehicle control actuator 70 by way of an in-vehicle LAN (local area network) or the like (not shown).

The vehicle control actuator 70 includes a plurality of units that control the behaviors of controlled objects in a body system, a powertrain system, and a chassis system of the vehicle. The controlled objects include a steering gear 71 (e.g., electric power steering), a speaker 72, a display 73, a controller 74 (e.g., brake), a driver 75 (e.g., accelerator), lights 76, and the like.

The vehicle control actuator 70 controls the behaviors of the controlled objects according to the running state of the vehicle. Besides, the vehicle control actuator 70 controls the behaviors of the controlled objects according to the commands from the ECU 50 to perform known vehicle controls, such as collision avoidance, speed warning, lane departure prevention, collision warning, inter-vehicle distance warning, lane departure warning, automatic high beam control, sign display, full speed range adaptive cruise control (ACC), lane keeping, lane change accident prevention, blind spot warning, blind spot monitoring, automatic lane change, front cross-traffic alerting, rear cross-traffic alerting, erroneous pedal depression prevention, and automatic parking. All of these vehicle controls do not have to be necessarily performed, but at least one of the controls may be ensured to be performed. The vehicle controls may be ensured to be appropriately performed according to externally given commands, or conditions included in the information which is derived from the sensor group 60.

The following is a detailed description of the abnormality determination process performed by the signal processor 22 of the microcomputer 20 in the vehicle control system 100. The process described below is performed at predetermined intervals.

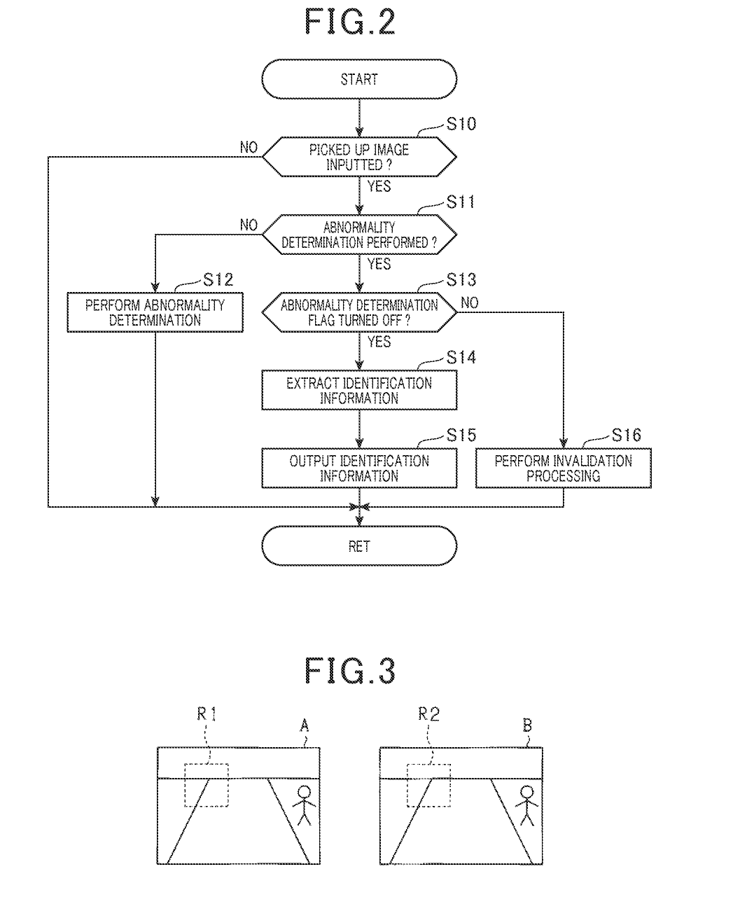

FIG. 2 is a flow diagram illustrating the abnormality determination process. As shown in FIG. 2, the signal processor 22 determines, in step S10, whether or not a picked up image has been inputted. Specifically, in step S10, an affirmative determination is made if image information is inputted to the image processing section 22b of the signal processor 22 from the external memory 30 via the interfaces 25 and 31. If an affirmative determination is made in step S10, the control proceeds to step S11 where it is determined whether or not the inputted picked up image has been determined as to its abnormality. If a negative determination is made in step S11, the control proceeds to step S12 where the picked up image is determined as to its abnormality.

In the abnormality determination process, the first and second image data stored at the first and second addresses, respectively, of the external memory 30 are called up via the interfaces 25 and 31 to determine whether or not the first and second image data match with each other. For example, as a comparison process, pixels configuring the individual pieces of image data are binarized at a predetermined luminance level. After binarization, it is determined whether or not there is a match in luminance information on pixels, at a predetermined proportion or more, between the first and second image data. If it is determined that there is a match between the first and second image data, an abnormality determination flag is turned off. On the other hand, if it is determined that there is not a match between the first and second image data, an abnormality determination flag is turned on.

If it is determined, in step S11, that abnormality determination has been conducted, the control proceeds to step S13 where it is determined whether or not the abnormality determination flag is turned off. In step S13, if the abnormality determination flag is determined to be turned off, the control proceeds to step S14 where identification information is extracted. For example, either (or both) of the first and second image data is called up (retrieved) from the external memory 30. The called up image data are subjected to known filtering to extract identification information. In step S15, the identification information is outputted to the ECU 50. In this case, based on the identification information, the ECU 50 outputs command signals for performing predetermined vehicle controls.

In step S13, if the abnormality determination flag is determined to be turned on, the control proceeds to step S16 where the image data are ensured not to be used for the process performed by the ECU 50. For example, the image data called up from the external memory 30 are subjected to an invalidation process. Alternatively, the image data in question are ensured not to be called up from the external memory 30. In this case, the ECU 50 will not execute control using the picked up image (image data). It should be noted that if a negative determination is made in step S10, the process is halted.

According to the image processor described above, the following prominent advantageous effects are obtained.

The microcomputer 20 is provided with the first and second capturing sections 21a and 21b by which a plurality of pieces of image data are acquired from a single picked up image. The plurality of pieces of image data acquired by the capturing sections 21a and 21b are stored in different memory cells 32 of the external memory 30 via the interfaces 25 and 31. Then, the microcomputer 20 is ensured to determine the presence/absence of an abnormality in the image-capturing route (including capturing sections 21a and 21b, and interfaces 25 and 31). The determination is based on whether or not there is a match between the image data derived from the single picked up image acquired from the external memory 30 via the interfaces 25 and 31. In this case, while the picked up image is acquired, collective determination can be made as to the presence/absence of an abnormality in the image-capturing route, using the acquired picked up image.

Under vehicle control, various image analyses are performed, using not only the currently acquired picked up image but also the picked up images acquired in the past. From this point of view, reliability is secured as far as the data derived from the capturing sections 21a and 21b are stored in the external memory 30 and the stored data are used.

If the abnormality determination processing section 22a determines that there is no abnormality, the ECU 50 is ensured to perform a process for assisting driving of the vehicle using the picked up image that has been determined as not having an abnormality. In this case, the ECU 50 is able to execute an appropriate process for assisting the driving of the vehicle using a normal picked up image.

The present invention should not be construed as being limited to the foregoing embodiment, but may be implemented as follows. In the following description, components identical with or similar to those in the foregoing embodiment are given the same reference numerals for the sake of omitting detailed description.

In the foregoing embodiment, abnormality determination may be conducted using data of part of the image area which is common to the first and second image data. For example, as shown in FIG. 3, abnormality determination may be conducted using data in an image area R1 in first image data A and data in an image area R2 in second image data B. In this case, the processing load of the microcomputer 20 can be mitigated.

If the abnormality determination processing section 22a determines that there is an abnormality in the image-capturing route, the processes of the first and second capturing sections 21a and 21b may be alternately performed in the image-capturing unit 21. Specifically, the configuration of providing two capturing sections to a single imaging means enables abnormality determination by mutual comparison of the picked up image data. On the other hand, normal picked up image data can be independently acquired from the respective capturing sections and used. In this case, the process of capturing a first picked up image conducted by the first capturing section 21a may be alternated with the process of capturing a second picked up image conducted by the second capturing section 21b. This alternate process can prevent a disadvantage from being entailed in the event that an abnormality is caused in one capturing section. Otherwise, such a disadvantage would have been entailed by the consecutive capturing of a picked up image by the capturing section in an abnormal state.

For example, when the first capturing section 21a has an abnormality, the image-capturing route is determined as having an abnormality. In this case, acquisition of image data by the first capturing section 21a may be alternated with the acquisition of image data by the second capturing section 21b. This alternate acquisition can prevent a disadvantage from being entailed, which would otherwise have been caused by allowing the first capturing section 21a in an abnormal state to consecutively perform a process of capturing image data. It should be noted that, irrespective of whether abnormality determination has been performed by the abnormality determination processing section 22a, acquisitions of image data by the first and second capturing sections 21a and 21b may be ensured to be alternated.

When a plurality of capturing sections are provided, different type of identification information can be extracted using the image data acquired by the respective capturing sections. For example, the first and second image data may be subjected to different image processes (e.g., gamma corrections). In other words, a more appropriate image process can be applied to each piece of image data, depending on the type of identification information. In this case, the accuracy of extracting identification information can be enhanced in the image processing section 22b and thus vehicle controls can be appropriately conducted using the identification information. In this case as well, the abnormality determination process described above can be performed at predetermined intervals to determine the presence/absence of an abnormality in the image-capturing route, while the accuracy of vehicle controls based on the identification information can be enhanced. If different pieces of identification information are extracted from the respective first and second image data, the extracted pieces of identification information can be used for different types of vehicle controls performed by the vehicle control actuator 70. In this way, ensuring detection of different types of identification information from the first and second picked up images, the ECU 50 is able to output a plurality of command signals on the basis of the different pieces of identification information. Thus, a plurality of types of vehicle controls can be simultaneously performed.

The foregoing embodiment has been described by way of an example of picking up an image in a forward direction in which the vehicle runs, using the imaging device 11. Alternatively, the above configuration may be applied to the case where an image is picked up in a lateral direction or in a rearward direction of the vehicle, using the imaging device 11.

The foregoing embodiment has been described by way of an example of performing abnormality determination using the first and second image data stored in the memory cells 32 of the external memory 30 via the image-capturing unit 21, and the interfaces 25 and 31. Alternatively, the first and second image data acquired by the image-capturing unit 21 may be stored in the RAM or the like, not shown, of the microcomputer 20 to have the abnormality determination processing section 22a call up the image information in the RAM and perform abnormality determination. In this case as well, the presence/absence of an abnormality in the image-capturing route can be determined at a time.

In the forgoing embodiment, all the picked up images have been subjected to the abnormality determination process performed by the abnormality determination processing section 22a. Alternatively, the abnormality determination process may be performed for selected picked up images.

It will be appreciated that the present invention is not limited to the configurations described above, but any and all modifications, variations or equivalents, which may occur to those who are skilled in the art, should be considered to fall within the scope of the present invention.

Hereinafter, aspects of the above-described embodiments will be summarized.

As an aspect of the embodiment, an in-vehicle apparatus is provided which acquires an image picked up by an imaging device (11) picking up an image around a vehicle. The apparatus includes: an image acquisition section (21) which includes a first capturing section (21a) and a second capturing section (21b) acquiring the picked up image; a storage section (30) which is connected to the image acquisition section via a communication section (25, 31) and stores a first picked up image acquired by the first capturing section and a second picked up image acquired by the second capturing section in different storage areas; an abnormality determination section (22a) which determines presence/absence of an abnormality of the image acquisition section and the communication section based on whether or not there is a match between the first picked up image and the second picked up image; an image processing section (22b) processes, if the abnormality determination section determines the absence of an abnormality, at least one of the first picked up image and the second picked up image stored in the storage section or a combined image generated by combining the first picked up image and the second picked up image, to detect at least one of an obstacle, a preceding vehicle, a preceding pedestrian, a preceding object, a stationary vehicle, a stationary pedestrian, a stationary object, an oncoming vehicle, an oncoming pedestrian, an oncoming object, a lane marker, a road surface condition, a road shape, a light source, a street sign, and a traffic signal as identification information around the vehicle; and a vehicle control section (50) which outputs, based on the identification information detected by the image processing section, a command signal for performing vehicle control related to at least one of collision avoidance, speed warning, lane departure prevention, collision warning, inter-vehicle distance warning, lane departure warning, automatic high beam control, sign display, full speed range adaptive cruise control, lane keeping, lane change accident prevention, blind spot warning, blind spot monitoring, automatic lane change, front cross-traffic alerting, rear cross-traffic alerting, erroneous pedal depression prevention, and automatic parking.

In the embodiment, the image acquiring means includes the first capturing section and the second capturing section to permit the capturing sections to acquire a plurality of picked up images from a single picked up image. The picked up images acquired by the capturing sections are stored in different storage areas of the storing means. Then, it is determined whether or not there is a match between the picked up images derived from the single picked up image and acquired from the storing means. Based on the determination as to matching, the presence/absence of an abnormality is ensured to be determined for the route for capturing the picked up image, the route including the image acquiring means and the communicating means. In this case, while a picked up image is acquired, the picked up image can be used for collectively determining the presence/absence of an abnormality in the image acquiring means and the communicating means which serve as the route for capturing the picked up image.

What is claimed is:

1. An in-vehicle apparatus which acquires an image picked up by an imaging device picking up an image around a vehicle, the apparatus comprising:
an image acquisition section which includes a first capturing section and a second capturing section acquiring the picked up image;
a storage section which is connected to the image acquisition section via a communication section and stores a first picked up image acquired by the first capturing section and a second picked up image acquired by the second capturing section in different storage areas;
an abnormality determination section which determines presence/absence of an abnormality of the image acquisition section and the communication section based on whether or not there is a match between the first picked up image and the second picked up image;
an image processing section processes, if the abnormality determination section determines the absence of an abnormality, at least one of the first picked up image and the second picked up image stored in the storage section or a combined image generated by combining the first picked up image and the second picked up image, to detect at least one of an obstacle, a preceding vehicle, a preceding pedestrian, a preceding object, a stationary vehicle, a stationary pedestrian, a stationary object, an oncoming vehicle, an oncoming pedestrian, an oncoming object, a lane marker, a road surface condition, a road shape, a light source, a street sign, and a traffic signal as identification information around the vehicle; and
a vehicle control section which outputs, based on the identification information detected by the image processing section, a command signal for performing vehicle control related to at least one of collision avoidance, speed warning, lane departure prevention, collision warning, inter-vehicle distance warning, lane departure warning, automatic high beam control, sign display, full speed range adaptive cruise control, lane keeping, lane change accident prevention, blind spot warning, blind spot monitoring, automatic lane change, front cross-traffic alerting, rear cross-traffic alerting, erroneous pedal depression prevention, and automatic parking.

2. The in-vehicle apparatus according to claim 1, wherein
the abnormality determination section determines presence/absence of an abnormality of an image-capturing route based on whether or not there is a match between the first picked up image and the second picked up image acquired via the image-capturing route including the image acquisition section and the communication section.

3. The in-vehicle apparatus according to claim 1, wherein the image processing section does not detect the identification information using either the first picked up image or the second picked up image stored in the storage section if the abnormality determination section determines that there is not a match between the first picked up image and the second picked up image.

4. The in-vehicle apparatus according to claim 1, wherein the abnormality determination section determines the abnormality using data of part of an image area which is common to the first picked up image and the second picked up image stored in the storage section.

5. The in-vehicle apparatus according to claim 1, wherein the process of capturing the first picked up image conducted by the first capturing section is alternated with the process of capturing the second picked up image conducted by the second capturing section.

6. The in-vehicle apparatus according to claim 1, wherein the image processing section detects first identification information from the first picked up image and detects second identification information from the second picked up image.

7. The in-vehicle apparatus according to claim 6, wherein
the vehicle control section outputs a first command signal based on the first identification information and a second command signal based on the second identification information.
